(19) United States
(12) Patent Application Publication
(10) Pub. No.: US 2026/0221796 A1
(43) Pub. Date: Jul. 30, 2026

(54) BATTERY CHARGER SYSTEM

(71) Applicants: Matthew D. Post, Brookfield, WI (US); Devlin N. Thyne, Brookfield, WI (US); Milwaukee Electric Tool Corporation, Brookfield, WI (US)

(72) Inventors: Matthew D. Post, Brookfield, WI (US); Devlin N. Thyne, Brookfield, WI (US)

(21) Appl. No.: 19/147,577

(22) PCT Filed: Jan. 12, 2024
(86) PCT No.: PCT/US2024/011363

§ 371 Date: Jul. 11, 2025

Related U.S. Application Data
(60) Provisional application No. 63/438,661, filed on Jan. 12, 2023.
(60) Provisional application No. 63/459,477, filed on Apr. 14, 2023.

(51) Int. Cl. H02J 7/90; H02J 7/00; H02J 7/34; H02J 7/44; H02J 7/45; H02J 7/50; H02J 107/20

(52) U.S. Cl. CPC H02J 7/933; H02J 7/342; H02J 7/44; H02J 7/45; H02J 7/50; H02J 7/855; H02J 7/971; H02J 2107/20; H02J 2207/30; H02J 2207/40

(57) ABSTRACT

A mobile power distribution system is provided. In one example embodiment, the mobile power distribution system can include a wireless module, a display with a graphical user interface, and a battery charger system. The wireless module can communicate data associated with the mobile power distribution system via one or more wireless communication links. The battery charger system can include one or more input power sources, a power bus coupled to the one or more input power sources, a communication bus coupled to the one or more input power sources and to the power bus, and one or more charger devices coupled to the power bus and the communication bus. The battery charger system can be configured to provide bus power to the one or more charger devices based at least in part on one or more arbitration schemes configured to allocate bus power between the one or more charger devices.

### PRIORITY CLAIM

The present application claims the benefit of priority to U.S. Provisional App. No. 63/459,477, titled “BATTERY CHARGER SYSTEM,” having a filing date of Apr. 14, 2023, which is incorporated by reference herein. The present application also claims the benefit of priority to U.S. Provisional App. No. 63/438,661, titled “BATTERY CHARGER SYSTEM,” having a filing date of Jan. 12, 2023, which is incorporated by reference herein.

### FIELD

Example aspects of the present disclosure generally relate to mobile power distribution systems. More particularly, example aspects of the present disclosure relate to battery charger systems for devices, such as, e.g., portable power tools.

### BACKGROUND

Portable tools may be powered by battery packs. Battery packs may need to be periodically charged after use. Battery charger systems may be used to charge battery packs for use in power tools.

### SUMMARY

Aspects and advantages of embodiments of the present disclosure will be set forth in part in the following description, or can be learned from the description, or can be learned through practice of the embodiments.

In one aspect, a battery charger system is provided. The battery charger system includes one or more input power sources configured to provide bus power to the battery charger system. The battery charger system includes a power bus coupled to the one or more input power sources. The battery charger system includes a communication bus coupled to the one or more input power sources and to the power bus. The battery charger system includes one or more charger devices coupled to the power bus and to the communication bus. The one or more charger devices are configured to receive bus power from the power bus. The battery charger system is configured to provide bus power to the one or more charger devices based, at least in part, on one or more arbitration schemes configured to allocate the bus power between the one or more charger devices.

In another aspect, a mobile power distribution system is provided. The mobile power distribution system includes a wireless module operable to communicate data associated with the mobile power distribution system via one or more wireless communication links. The mobile power distribution system includes a display with a graphical user interface (GUI). The mobile power distribution system includes a battery charger system configured to provide bus power to one or more charger devices based, at least in part, on one or more arbitration schemes. The battery charger system includes one or more input power sources, a power bus coupled to the one or more input power sources, and a communication bus coupled to the one or more input power sources and to the power bus.

In another aspect, a method for providing power to one or more charger devices of a battery charger system comprising one or more input power sources is provided. The method includes receiving one or more power requests received from the one or more charger devices. The method includes, responsive to receiving the one or more power requests, determining the one or more power requests exceed the power threshold associated with the battery charger system. The method includes, responsive to determining the one or more power requests exceed the power threshold, providing power to at least one charger device of the one or more charger devices.

In another aspect, a battery charger system is provided. The battery charger system includes one or more input power sources configured to provide bus power to the battery charger system. The battery charger system includes a power bus coupled to the one or more input power sources. The battery charger system includes a communication bus coupled to the one or more input power sources and to the power bus. The battery charger system includes one or more charger devices coupled to the power bus and to the communication bus, the one or more charger devices being configured to receive bus power from the power bus. The battery charger system includes a bidirectional battery bank, the bidirectional battery bank being configured to receive bus power from the one or more input power sources and provide bus power to the one or more charger devices. The battery charger system includes an output adapter, the output adapter being operable to convert bus power from the battery charger system into AC power for one or more external devices configured to operate on AC power. The battery charger system includes a controller coupled to the power bus and the communication bus.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a battery charger system according to example embodiments of the present disclosure;

FIG. 2 depicts a battery charger system according to example embodiments of the present disclosure;

FIG. 3A depicts a battery charger system with decentralized arbitration according to example embodiments of the present disclosure;

FIG. 3B depicts the battery charger system with decentralized arbitration of FIG. 3A according to example embodiments of the present disclosure;

FIG. 4A depicts a battery charger system with centralized arbitration according to example embodiments of the present disclosure;

FIG. 4B depicts the battery charger system with centralized arbitration of FIG. 4A according to example embodiments of the present disclosure;

FIG. 5 depicts an example power input of a battery charger system according to example embodiments of the present disclosure;

FIG. 6 depicts an example tool battery charger of a battery charger system according to example embodiments of the present disclosure;

FIG. 7 depicts an example bus output adapter of a battery charger system according to example embodiments of the present disclosure;

FIG. 8 depicts an example battery bank of a battery charger system according to example embodiments of the present disclosure;

FIG. 9 depicts a mobile power distribution system according to example embodiments of the present disclosure;

FIG. 10 depicts example wired communication among components according to example embodiments of the present disclosure;

FIG. 11 depicts example wireless communication among components according to example embodiments of the present disclosure;

FIG. 12A depicts an example interlock system according to example embodiments of the present disclosure;

FIG. 12B depicts an example interlock system according to example embodiments of the present disclosure;

FIG. 12C depicts an example interlock system according to example embodiments of the present disclosure;

FIG. 13 depicts a flow chart of an example method implemented by bus power sources according to example embodiments of the present disclosure;

FIG. 14 depicts a flow chart of an example method implemented by bus power consumers according to example embodiments of the present disclosure;

FIG. 15 depicts a flow chart of an example method implemented by energy storage devices according to example embodiments of the present disclosure;

FIG. 16 depicts a flow chart of an example method implemented by output inverters according to example embodiments of the present disclosure;

FIG. 17 depicts a flow chart of an example method for input power source sharing according to example embodiments of the present disclosure;

FIG. 18 depicts an example power consumer prioritization scheme according to example embodiments of the present disclosure;

FIG. 19 depicts an example power source prioritization scheme according to example embodiments of the present disclosure;

FIG. 20 depicts a flow diagram of an example method for providing power to one or more charger devices of a battery charger system according to example embodiments of the present disclosure; and

FIG. 21 depicts a flow diagram of an example method for providing power to one or more charger devices of a battery charger system according to example embodiments of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure relate generally to the field of mobile power distribution. For instance, example aspects of the present disclosure relate to power distribution in mobile battery charger systems.

A mobile power distribution system can include a battery charger system configured to provide power to one or more charger devices (e.g., power tool chargers). The battery charger system can include one or more input power sources configured to provide power to one or more charger devices via a power bus. The battery charger system can further include a communication bus coupled to the power bus and to both the one or more input power sources and the one or more charger devices. Furthermore, the communication bus can facilitate communication between the one or more charger devices and the one or more input power sources. In some embodiments, the one or more charger devices can be configured to transmit data indicative of one or more electrical characteristics of the one or more charger devices, such as, e.g., a maximum power draw capacity of each of the one or more charger devices, requested charger power of each of the one or more charger devices, current power draw of each of the one or more charger devices, etc.

In some embodiments, the mobile power distribution system can include various connectivity features, such as, e.g., a wireless module. For instance, in some embodiments, the wireless module can be operable to communicate data associated with the mobile power distribution system to a user and/or a third party via one or more wireless communication links. Additionally, the wireless communication links can be configured to communicate via one or more wireless communication protocols, such as, e.g., WiFi, Bluetooth, and/or cellular communication protocols (e.g., 4G/5G).

The mobile power distribution system can further include a variety of user interfaces. For instance, in some embodiments, the mobile power distribution system can include a display configured to display a graphical user interface. In some embodiments, the display can display one or more metrics indicative of system performance of the mobile distribution system to the user. Furthermore, in some embodiments, the mobile power distribution system can be configured to allow the user to determine a variety of system settings, preferences, etc. via user input on the display. The mobile power distribution system can further include a variety of other interfaces (e.g., LEDs) configured to convey information indicative of system performance to the user.

As will be discussed in greater detail below, the charger device(s) can be configured to charge power tool batteries. For instance, the charger device(s) can have one or more charging ports configured to charge one or more batteries. However, whether the charger device(s) are capable of providing a charge to the batteries depends on a variety of constraints, such as, e.g., the type of input power source(s), the amount of power produced by the input power source(s), the presence (or absence) of other batteries connected to the battery charging system, etc. For instance, input power source(s) configured to provide a low amount of power will not be able to provide the same amount of charge to the system and will not be able to timely charge connected batteries as input power source(s) configured to provide a high amount of power. Furthermore, if a device connected to the system draws a high amount of power, the battery charger system will not be able to provide power to other devices connected to the system. As such, a reliable and dynamic battery charger system configured to provide robust power distribution is desired.

Accordingly, example aspects of the present disclosure provide a mobile power distribution system having a battery charger system configured to provide reliable and dynamic power distribution. For instance, example aspects of the present disclosure provide a battery charger system configured to provide bus power to one or more charger devices based at least in part on one or more arbitration schemes (e.g., decentralized arbitration, centralized arbitration) and/or one or more prioritization schemes (e.g., time-dependent prioritization schemes, user-input prioritization schemes, or intrinsic prioritization schemes). In this way, example aspects of the present disclosure provide a mobile power distribution system capable of operating across a wide range of environments. The mobile power distribution system is also capable of charging a variety of different devices while simultaneously providing power to other equipment requiring, e.g., AC power.

The systems and methods according to example embodiments of the present disclosure provide a number of technical effects and benefits. For instance, example aspects of the present disclosure provide a mobile battery charger configured to provide power to one or more charging devices based at least in part on one or more arbitration schemes and/or prioritization schemes. In this way, the battery charger system can provide power to a number of different power tool batteries and/or other equipment without overloading the system and exceeding the input power from the one or more input power devices. Furthermore, example aspects of the present disclosure provide systems and methods capable of charging batteries and providing power to run other equipment at the same time. Even further, by adjusting power output based on, e.g., the one or more power input(s), example aspects of the present disclosure provide systems and methods capable of providing reliable power distribution regardless of the input power source. In this way, systems and methods of the present disclosure can provide for reliable power distribution for, e.g., work trucks at a worksite and/or other situations where standard wall outlets and/or other traditional power sources are not accessible.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

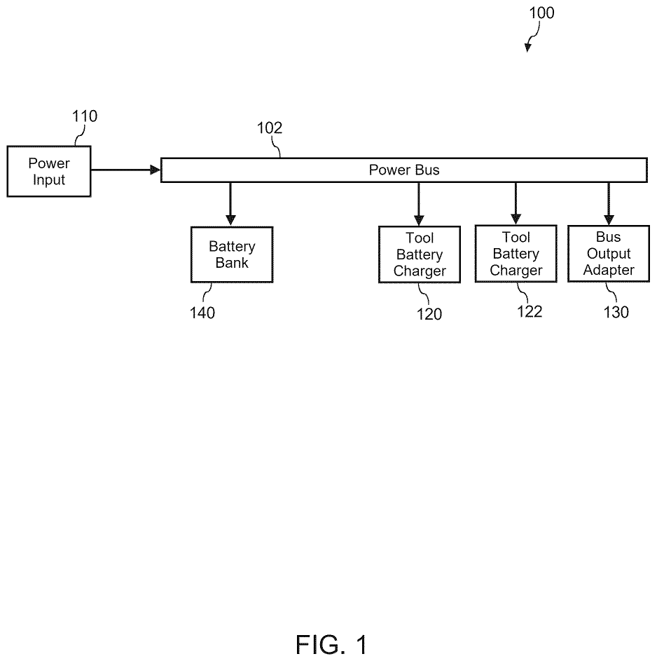

FIG. 1 depicts an example battery charger system 100 according to example embodiments of the present disclosure. The battery charger system 100 can include a bidirectional power bus 102 configured to provide power to one or more components of the battery charger system 100. In some embodiments, the one or more components of battery charger system 100 can share a common bus voltage (e.g., about 48 V to about 400 V DC).

The battery charger system 100 can include one or more input power source(s) coupled to the power bus 102 and configured to provide power to the power bus 102. For instance, as shown in FIG. 1, the system 100 can include input power source 110. It should be noted that battery charger system 100 is depicted with one input power source for purposes of illustration. As will be discussed in greater detail below, battery charger systems according to example embodiments of the present disclosure can include any suitable number of input power sources without deviating from the scope of the present disclosure.

The battery charger system 100 can include one or more load device(s) coupled to the power bus 102 and configured to receive power from the power bus 102. For instance, as shown in FIG. 1, the battery charger system 100 can include one or more load devices, such as battery chargers 120, 122 and output adapter 130. As will be discussed in greater detail below, battery charger systems according to example embodiments of the present disclosure can include any suitable number of load devices without deviating from the scope of the present disclosure.

In some embodiments, the battery charger system 100 can further include additional bidirectional component(s) configured to provide power to the power bus 102 and/or receive power from the power bus 102. For instance, as shown in FIG. 1, the battery charger system 100 can include an additional bidirectional component, such as battery bank 140. In some embodiments, battery bank 140 can provide power to the power bus 102. Additionally and/or alternatively, battery bank 140 can receive power from the power bus 102 when other power source(s) (e.g., input power source 110) are available to provide power to the power bus 102.

It should be understood that, as used herein, a “bus power consumer” refers to any device that requests and/or receives bus power from the power bus 102. For instance, in some examples, the one or more load devices discussed herein (e.g., battery chargers 120, 122 and output adapter 130) are configured to request bus power from the power bus 102 and receive bus power from the power bus 102. As such, the one or more load devices are considered “bus power consumers.” Additionally and/or alternatively, the bidirectional battery bank 140 may, in some examples, be configured to receive bus power from the power bus 102. As such, in some examples, the bidirectional battery bank 140 is considered a “bus power consumer.” Furthermore, those having ordinary skill in the art, using the disclosures provided herein, will appreciate that the terms “bus power” refers to power from the power bus 102. As such, the terms “bus power” and “power” may be used interchangeably herein.

Furthermore, the battery charger system 100 can include one or more computing devices configured to operate the battery charger system 100. In some embodiments, the one or more computing devices can be configured to determine one or more electrical characteristics of the input power sources 110, 112. Furthermore, the one or more computing devices can be configured to receive one or more power requests from the one or more load device(s) such as, e.g., battery chargers 120, 122, and the one or more computing devices can process the one or more power requests received from the one or more load device(s). Even further, the one or more computing devices can be configured to distribute bus power to each of the one or more load device(s) based, at least in part, on the one or more electrical characteristics of the input power sources 110, 112 and the one or more power requests received from the one or more load device(s). In some embodiments, the one or more computing devices can include a controller (not shown) coupled to a communication bus (not shown).

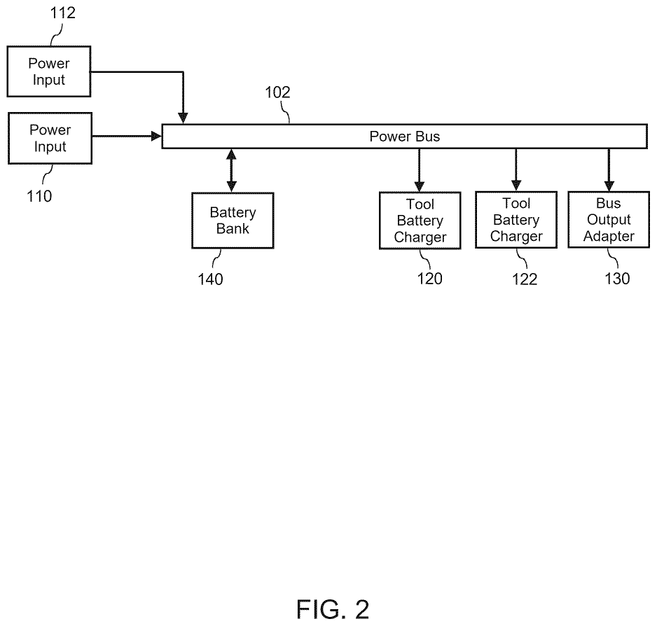

FIG. 2 depicts the example battery charger system 100 according to example embodiments of the present disclosure. As noted above, battery charger systems according to example embodiments of the present disclosure can include one or more input power source(s) coupled to the power bus 102 and configured to provide power to the power bus 102. For instance, in addition to input power source 110, the battery charger system 100 can include input power source 112. As shown in FIG. 2, input power source 110 and input power source 112 can be arranged to provide power to power bus 102 in a parallel configuration. In some embodiments, input power source 110 and input power source 112 can be the same type of power source. Additionally and/or alternatively, input power source 110 and input power source 112 can be different types of power sources. As will be discussed in greater detail below, the one or more input power source(s) (e.g., input power source 110 and input power source 112) can be any suitable power source, such as, e.g., a shore power source (e.g., 120 VAC, 240 VAC), a vehicle battery, an inverter, a solar power system, a battery bank (e.g., battery bank 140), etc.

According to example aspects of the present disclosure, one or more load device(s) can communicate with one another in order to facilitate real-time power adjustment by the battery charger system 100. More particularly, rather than measuring an amount of power being drawn by downstream load devices, each of the load devices can communicate an amount of power being drawn by that load device individually. In this way, each load device can monitor a variety of metrics associated with the battery charger system 100 (e.g., total power available, total power in use, etc.). Furthermore, in the event the total power draw of all load devices approaches a system power threshold (e.g., circuit maximum), each of the one or more load device(s) can, e.g., reduce their respective charging current or halt charging until more power is available.

As will be discussed in greater detail below, the one or more load device(s) and/or the one or more input power source(s) can communicate over a communication bus. For instance, in some embodiments, the one or more input power source(s) can communicate a total amount of power available for the one or more load device(s) over the communication bus. Additionally, the one or more load device(s) (e.g., battery chargers) can communicate a variety of information over the communication bus, such as, e.g., a maximum power draw capability, an amount of requested power, an amount of current power being drawn, faults, and/or an indication that the device is waiting to charge.

In some embodiments, the battery charger system 100 can implement a variety of arbitration methods for power management amongst the one or more load device(s). In some embodiments, the battery charger system 100 can use a centralized arbitration method. In centralized arbitration, a centralized device (e.g., a centralized controller) accounts for the power inputs and power outputs of the battery charger system 100. Based at least in part on the power inputs and outputs, the centralized device can assign power to each of the one or more load device(s). In this way, the centralized device operates to control power distribution in the battery charger system 100.

Additionally and/or alternatively, in some embodiments, the battery charger system 100 can use a decentralized arbitration method. In decentralized arbitration, as power is made available from the one or more input power source(s), each of the one or more load device(s) can try to claim an amount of power. In this way, decentralized arbitration methods provide for power management without the need for a centralized controller. Furthermore, in the event more than one load device of equal prioritization tries to claim the same amount of power, example aspects of the present disclosure provide a variety of claim collision arbitration methods (also referred to herein as “collision arbitration schemes”). For instance, such claim collision arbitration methods can include, e.g., random time backoff and/or serial number prioritization. In random time backoff, each load device waits a random amount of time before re-asserting their respective power claim. In serial number prioritization, devices with newer serial numbers are prioritized for charging. Additionally and/or alternatively, in some embodiments, in serial number prioritization, devices with older serial numbers are prioritized for charging.

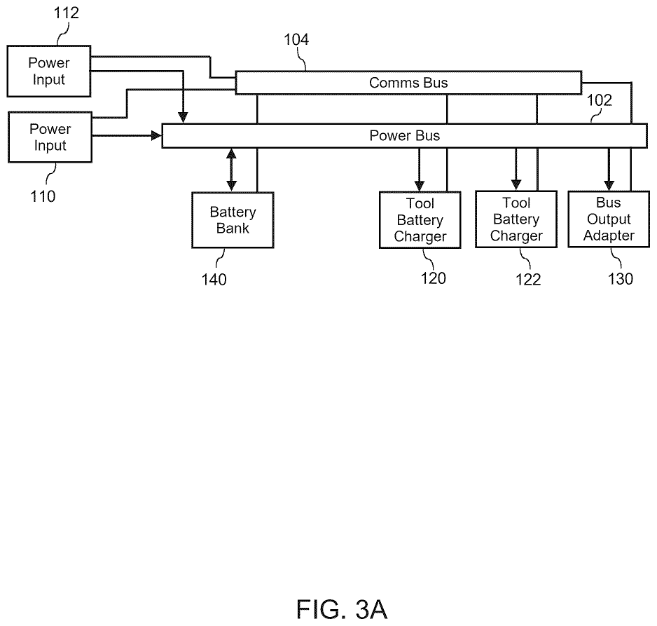

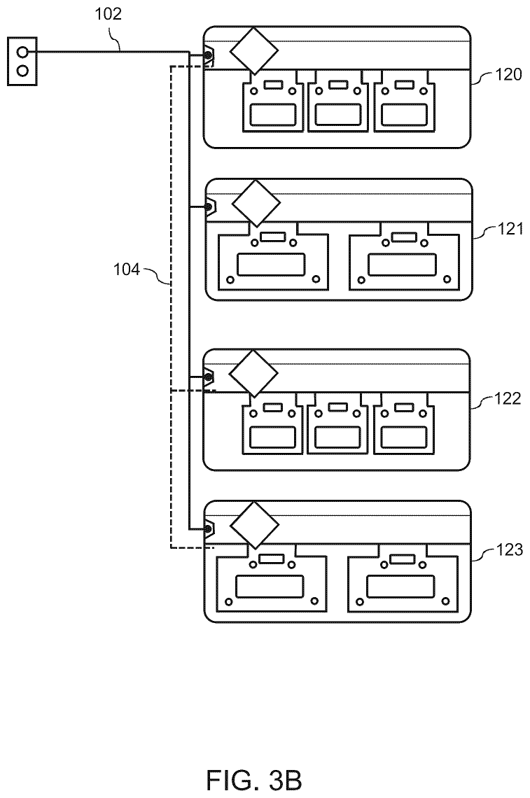

For instance, FIGS. 3A and 3B depict an example embodiment of the battery charger system 100 with decentralized arbitration. As shown in FIG. 3A and as noted above, the battery charger system 100 can include a communication bus 104 over which the various components of battery charger system 100 can communicate. For instance, in decentralized arbitration, each of the one or more load device(s) (e.g., battery chargers 120, 122, output adapter 130, battery bank 140) and each of the one or more input power source(s) (e.g., input power sources 110, 112) can communicate information indicative of the power capabilities and needs of each respective component over the communication bus 102. Furthermore, each of the one or more load device(s) is knowledgeable of overall battery charger system 100 power requirements. In this way, each of the one or more load device(s) and each of the one or more input power source(s) can negotiate the amount of power available and the amount of power each load device can respectively draw. In some embodiments, operation can be similar to a Controller Area Network (CAN bus).

FIG. 3B depicts an alternative perspective of the example battery charger system 100 with decentralized arbitration depicted in FIG. 3A. As shown in FIG. 3B, battery chargers 120, 121, 122, 123 can be coupled to the power bus 102 and can be configured to communicate over the communication bus 104.

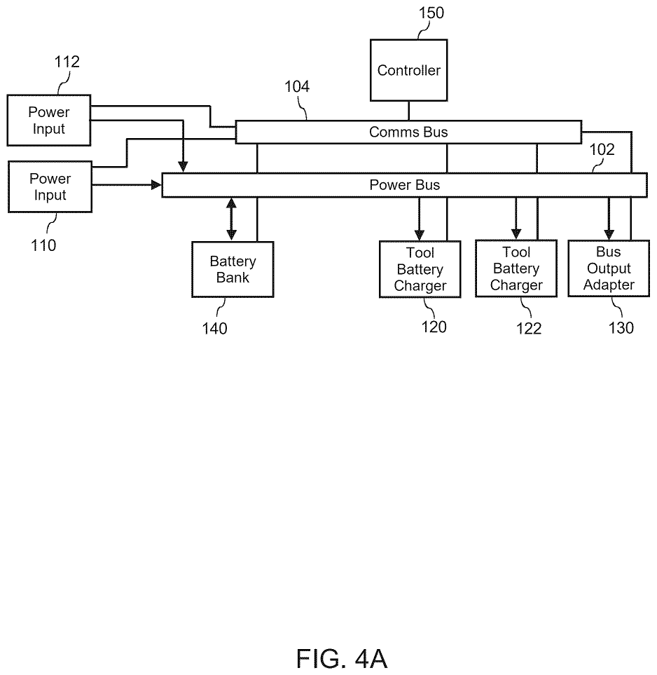

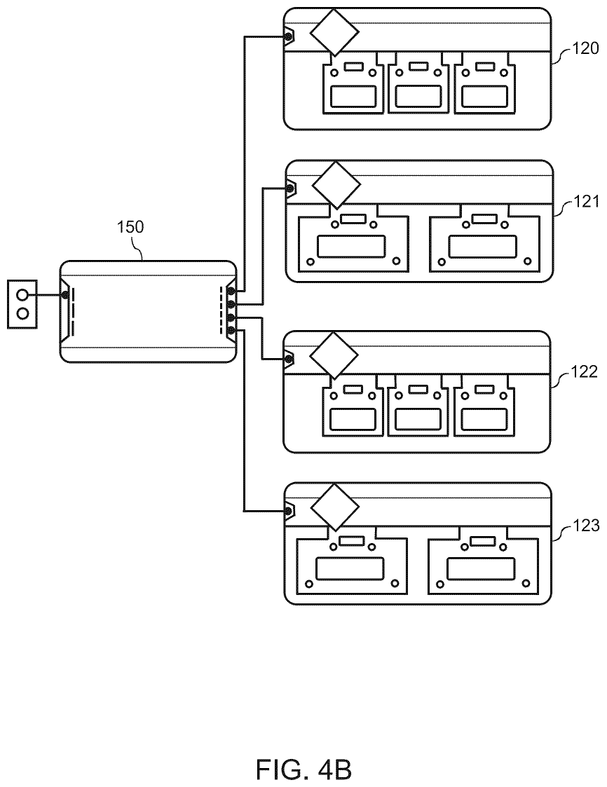

Referring now to FIGS. 4A and 4B, an example embodiment of the battery charger system 100 with centralized arbitration is depicted. As shown in FIG. 4A and as noted above, the battery charger system 100 can include a centralized controller 150 configured to control power draw for the system 100. Controller 150 can be communicatively coupled to each of the one or more load device(s) (e.g., battery chargers 120, 122, output adapter 130, battery bank 140) and to each of the one or more input power source(s) (e.g., input power sources 110, 112). In this way, controller 150 can determine power draw associated with each of the one or more load device(s) (e.g., battery chargers 120, 122, output adapter 130, battery bank 140) and power limits associated with each of the one or more input power source(s) (e.g., input power sources 110, 112). Controller 150 can determine an allowed power draw for each of the one or more load device(s) based at least in part on the power limits of the one or more input power source(s). Controller 150 can communicate the allowed power draw to each of the one or more load device(s), and each of the one or more load device(s) will then charge at the respective allowed power. In this way, controller 150 can limit the power of the battery charger system 100.

FIG. 4B depicts an alternative perspective of the example battery charger 100 with centralized arbitration depicted in FIG. 4A. As shown in FIG. 4B, battery chargers 120, 121, 122, 123 can be coupled to the power bus 102 and can be configured to communicate over the communication bus 104. Furthermore, the controller 150 can likewise be coupled to the power bus 102 and can be configured to communicate over the communication bus 104. In this way, controller 150 can control power distribution in the battery charger system 100.

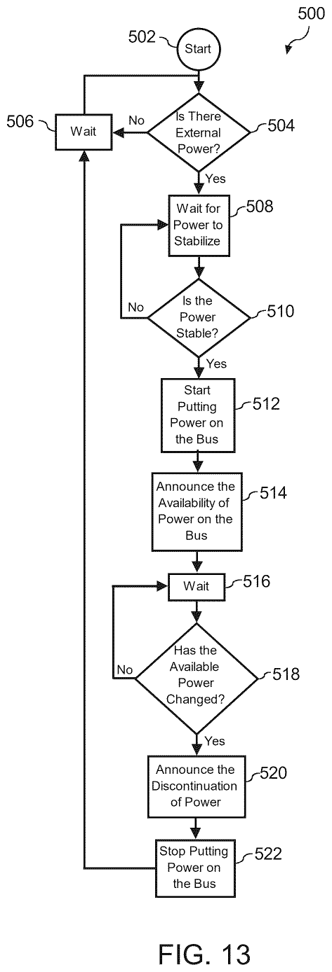

Referring to both FIG. 4A and FIG. 4B, the controller 150 may be configured to control operation of the battery charger system 100 and its corresponding components by performing a variety of control operations. The controller 150 may also be configured to control power distribution to and from the power bus 102. More particularly, the controller 150 may include one or more processors. For instance, the controller 150 may include any suitable processing device (e.g., a processor core, a microprocessor, an application specific integrated circuit (AISC), a field programmable gate array (FPGA), a microcontroller, etc.). The controller 150 may further include a memory. For instance, the controller 150 may include one or more non-transitory computer-readable storage media, such as random access memory (RAM), read-only memory (ROM), electronically erasable programmable ready-only memory (EEPROM), erasable programmable read-only memory (EPROM), flash memory devices, and combinations thereof. In this manner, the controller 150 may store data and instructions that, when executed by the one or more processors, cause the one or more processors to perform the operations disclosed herein, such as the methods 500-900 described below with reference to FIGS. 13-17, respectively.

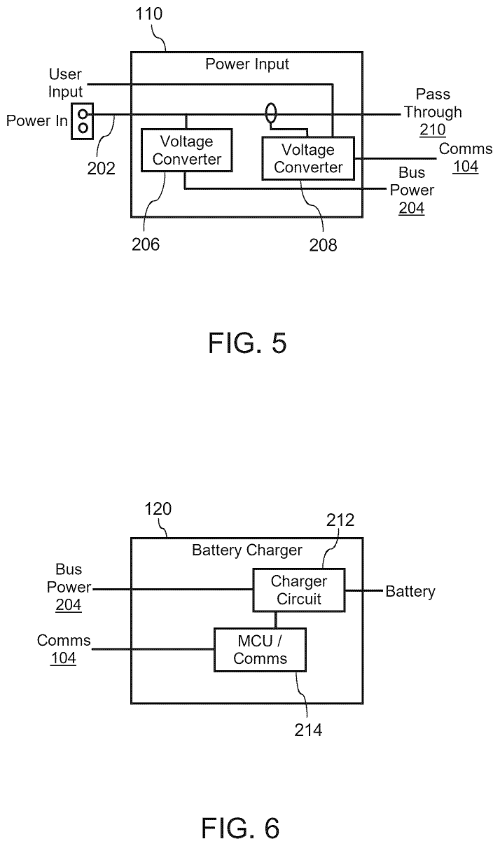

FIG. 5 depicts an example input power source (e.g., input power source 110) of the battery charger system 100 according to example embodiments of the present disclosure. As noted above, in some embodiments, input power source 110 can be the same as input power source 112. Thus, those having ordinary skill in the art will appreciate that the discussion in reference to FIG. 5 can be equally applied to input power source 112 without deviating from the scope of the present disclosure.

As shown, input power source 110 can convert external power 202 to bus power 204 for use by the battery charger system 100 (e.g., via voltage converters 206, 208). Furthermore, input power source 110 can transmit to the battery charger system 100 (e.g., via communication bus 104) data indicative of one or more electrical characteristics of the input power source 110, such as, e.g., its maximum power output. In some embodiments, input power source 110 can include a pass-through plug 210 on alternating current (AC) power inputs in order to provide AC power to any of the one or more load device(s) (not shown) that operate on AC power. Input power source 110 can measure and subtract the power drawn of pass-through plug 210 from its maximum power to determine an adjusted maximum power. Input power source 110 can then communicate the adjusted maximum power to battery charger system 100.

Additionally and/or alternatively, a user of the battery charger system 100 can adjust the power capability of input power source 110 via, e.g., a switch or a wireless connection. For instance, a 120 VAC input power source can be moved to a lower power inverter input via the user. Instead of the normal power draw from shore power, the user can reconfigure the input power source to communicate its reduced power capability to the battery charger system 100.

FIG. 6 depicts an example battery charger (e.g., battery charger 120) of the battery charger system 100 according to example embodiments of the present disclosure. Those having ordinary skill in the art will understand that the discussion in reference to FIG. 6 can be applied to any of the battery chargers disclosed herein without deviating from the scope of the present disclosure.

As shown, battery charger 120 can convert bus power 204 to charge a power tool battery (e.g., via charger circuit 212). Battery charger 120 can transmit data indicative of one or more electrical characteristics associated with the battery charger 120, such as, e.g., its rated power to the battery charger system 100 (e.g., via communication bus 104). In some embodiments, battery charger 120 can transmit the data indicative of the one or more electrical characteristics associated with the battery charger 120 to the battery charger system 100 via one or more wireless communication links.

As shown, in some embodiments, battery charger 120 can include one or more components (e.g., microcontroller 214) to facilitate communication between the battery charger 120 and the battery charger system 100. Furthermore, the battery charger 120 will charge at its rated power if that amount of power available. If the rated amount of power is not available, battery charger 120 can reduce its charge rate to start charging the battery without overloading the system.

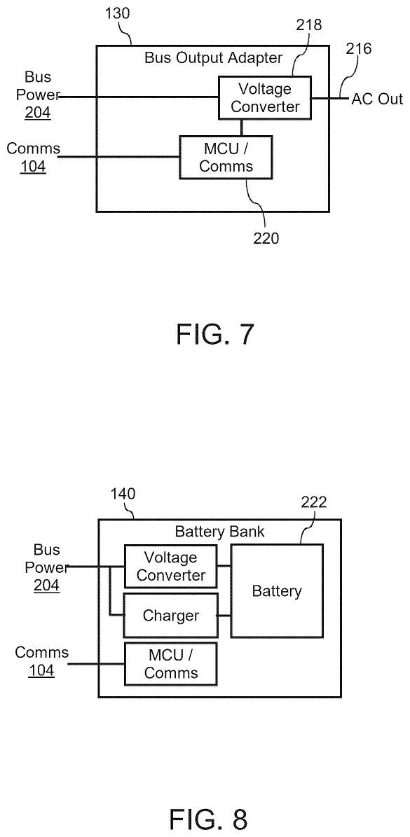

FIG. 7 depicts an example bus output adapter (e.g., output adapter 130) of the battery charger system 100 according to example embodiments of the present disclosure. Output adapter 130 can convert bus power 204 to AC power 216 (e.g., via voltage converter 218) for use by one or more external devices (e.g., tools) connected to the output adapter 130. Those having ordinary skill in the art will understand that, in this way, output adapter 130 can operate in a similar manner to an inverter. Furthermore, output adapter 130 can communicate its power usage to the battery charger system 100 (e.g., via communication bus 104).

As shown, in some embodiments, output adapter 130 can include one or more components (e.g., microcontroller 220) to facilitate communication between the output adapter 130 and the system 100. If the external device (e.g., tool) draws too much power, the output adapter 130 can shut off to protect the system 100. In this way, users of system 100 can use tools and/or equipment requiring AC power without overloading the one or more input power source(s).

FIG. 8 depicts an example battery bank (e.g., battery bank 140) of the battery charger system 100 according to example embodiments of the present disclosure. As noted above, battery bank 140 can be a bidirectional power source configured to provide power to the system 100 when additional input power sources are not available. In some embodiments, when shore power is available to the system 100, battery bank 140 can charge its battery 222.

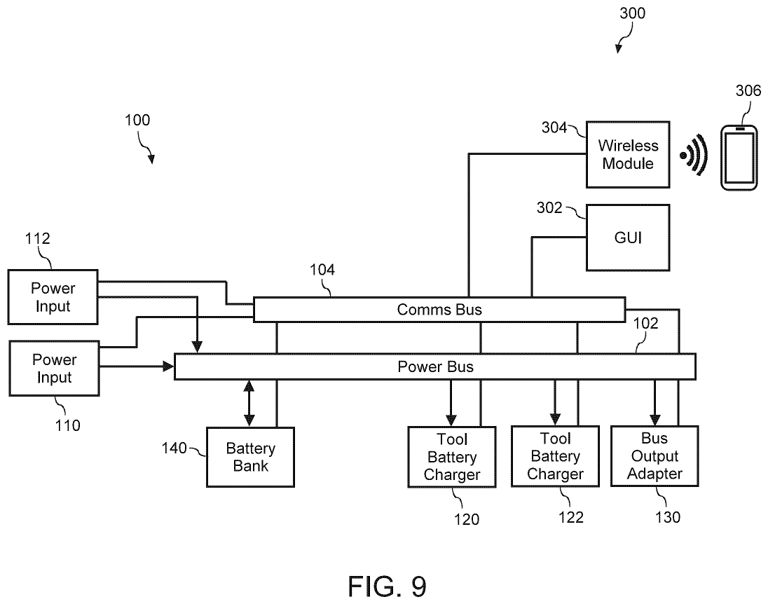

FIG. 9 depicts a mobile power distribution system 300 according to example embodiments of the present disclosure. As shown, the mobile power distribution system 300 can include the battery charger system 100 discussed above with reference to FIGS. 1-8. As noted above, battery charger system 100 may use a plurality of different methods and/or algorithms for power negotiations and power consumption prioritizations, such as, e.g., first-in first-out (FIFO), time-dependent prioritization, user-input prioritization, intrinsic prioritization, or any other suitable prioritization method and/or algorithm.

In FIFO, batteries placed first on the battery charger system 100 (e.g., via battery chargers 120, 122) will charge first. For instance, if a first battery is placed on the battery charger system 100 via battery charger 120 before a second battery is placed on the system 100 via battery charger 122, the first battery will charge before the second battery.

Time-dependent prioritization may include, for instance, “time-of-day” prioritization and/or “round-robin” prioritization. In “time-of-day” prioritization, power to charge a battery placed on the battery charger system 100 (e.g., via battery chargers 120, 122) would be higher during a time of day when it needs to charge quickly (e.g., during work hours) and would be lower at a time of day when it can charge at a slower rate (e.g., at night). In “round-robin” prioritization, each of the one or more load device(s) (e.g., battery chargers 120, 122, output adapter 130, battery bank 140) gets a period in which to draw power from the battery charger system 100. In some embodiments, the charge period in “round-robin” prioritization is shorter than full charge time.

User-input prioritization may include, for instance, “user-selected” priority and/or “user-set” priority. In “user-selected” priority, a user of the battery charger system 100 can press a button and/or other interface on a charger (e.g., battery chargers 120, 122) to have the connected battery charge with priority. In “user-set” priority, the user of the battery charger system 100 can select a charger (e.g., battery chargers 120, 122) to always charge the connected batteries with priority.

Intrinsic prioritization may include, for instance, determining priority based on qualities and/or features of a device connected to the one or more load device(s) (e.g., battery chargers 120, 122, output adapter 130, battery bank 140). In some embodiments, some qualities and/or features of devices can necessitate higher prioritization, and other qualities and/or features of devices can necessitate lower prioritization. For instance, lighting in a trailer or supplemental cooling fans may require higher prioritization. Additionally and/or alternatively, certain battery packs and/or other loads may have a higher capacity and, thus, may require a higher prioritization.

Referring still to FIG. 9, the mobile power distribution system 300 may include one or more user interface (UI) elements. For instance, a battery charger may include a button or other element (not shown) to set charge priority. The battery charger may include an indicator (e.g., LED light) to provide individual battery charge status to a user.

Furthermore, as shown in FIG. 9, the mobile power distribution system 300 can include a graphical user interface (GUI) 302 (e.g., on a display screen associated with the mobile power distribution system 300 or on a device 306 in communication with the battery charger system 100). The GUI 302 may be a separate interface for monitoring overall stats of the mobile power distribution system 300. For instance, the GUI 302 can provide for display the power draw of each component in the mobile power distribution system 300. Additionally and/or alternatively, the GUI 302 can provide for display the charge status of all battery packs associated with the one or more battery chargers (e.g., battery chargers 120, 122). In some embodiments, the GUI 302 can be built into a centralized component (e.g., a power source) (not shown). In other embodiments, the GUI 302 can be shown on an application presented on a mobile device 306 (e.g., smartphone, tablet, etc.). A user can interact with the mobile power distribution system 300 through the GUI 302. For instance, the user can, e.g., program parameters into the mobile power distribution system 300 via the GUI 302, limit power draw from certain components of the mobile power distribution system 300 via the GUI 302, and/or change charge priority via the GUI 302.

Referring still to FIG. 9, the mobile power distribution system 300 can include one or more components (e.g., wireless module 304) which communicate with users and/or third parties via a variety of wireless communication links. For instance, the mobile power distribution system 300 can be configured to communicate with users and/or third parties over a variety of wireless communication protocols such as, e.g., WiFi, Bluetooth, LoRa, LTE-Cat-M1, 4G/5G Cellular, etc. The connectivity portion (e.g., wireless module 304) allows for data communication such as: status of connected component and batteries; firmware updates of tools, batteries, chargers, system components, etc.; device telemetry and history of tools, batteries, chargers, system components, etc.; charge and/or power prioritization management of bus components; software and hardware security locks; geographic location; utility-scale usage requests (e.g., power utility approaching grid overload condition requests chargers to stop charging until overload condition passes); and more.

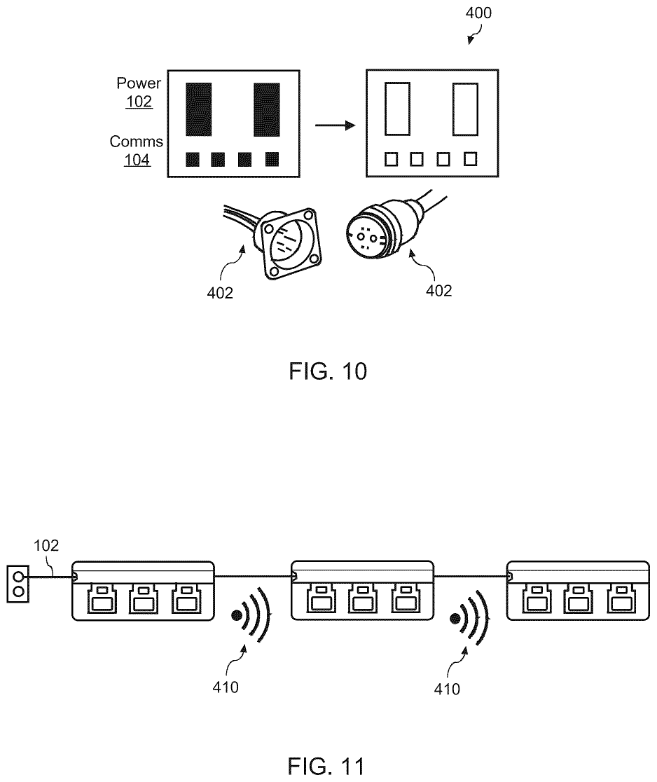

As discussed above, example embodiments of the present disclosure provide for communication between the components of the battery charger system 100. In some embodiments, components of the battery charger system 100 can be configured to communicate via a wired connection. For instance, FIG. 10 depicts an example embodiment for wired communication amongst components of the battery charger system 100. As shown, the battery charger system 100 can include connector system 400 configured to facilitate communication amongst the various components. For instance, components can be connected together through a cable 402. In this way, the system can provide a separate communication bus (e.g., communication bus 104). Additionally and/or alternatively, communications can also be sent over the power bus (e.g., power bus 102 using powerline communication (PLC) protocols).

In alternative embodiments, components of the battery charger system 100 can be configured to communicate via one or more wireless communication links. For instance, FIG. 11 depicts an example embodiment for wireless communication amongst components of the battery charger system 100. As shown, the components of battery charger system 100 can be configured to communicate via one or more wireless communication links 410 using wireless communication protocols, such as, e.g., WiFi, Bluetooth, IEEE 802.15.4, proprietary ISM Band signals, etc.

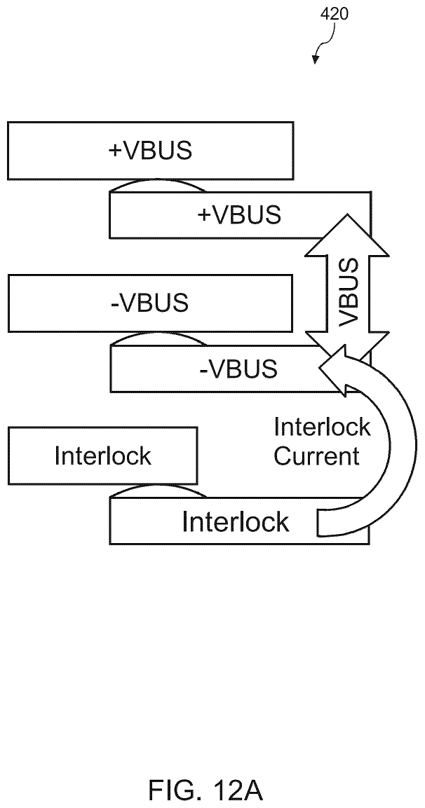

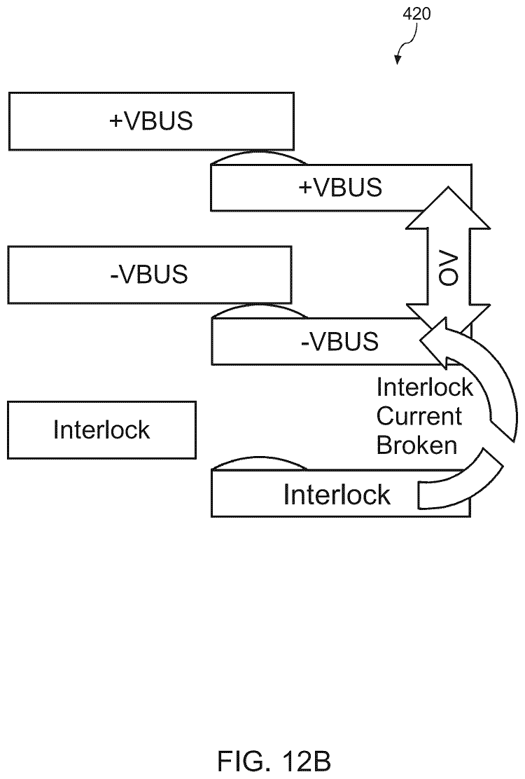

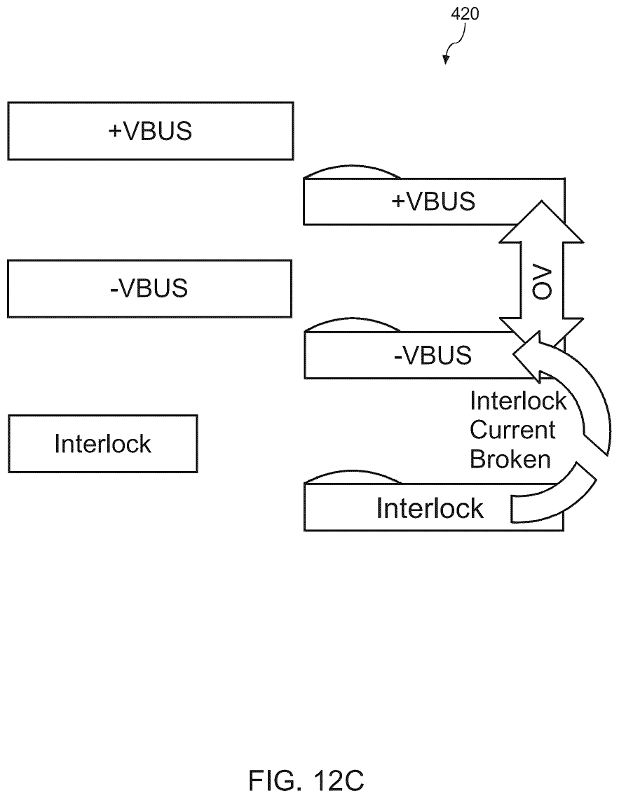

FIGS. 12A-12C depict an example interlock system 420 according to example embodiments of the present disclosure. More particularly, FIG. 12A depicts a mated connection in the interlock system 420. FIG. 12B depicts a partially mated connection in the interlock system 420. FIG. 12C depicts an unmated connection in the interlock system 420.

In some embodiments, the battery charger system 100 can include one or more interlock systems 420 having one or more interlock loop conductors to protect the battery charger system 100 and/or the mobile power distribution system 300 from, e.g., overload power conditions. For instance, in some embodiments, the communication bus 104 can implement heartbeat signaling to provide continuous monitoring and feedback on the status of the interlock system 420. Furthermore, signaling from the communication bus 104 can be superimposed on one or more interlock loop conductor(s).

In some embodiments, the interlock system 420 can include a microswitch(s) on a bus port connection that opens prior to exposure of live conductors. Furthermore, both positive lines and negative lines of the power bus 102 can include interlock systems 420. In some embodiments, arc-detection circuits can disrupt high-voltage conductors prior to possible exposure. One or more coaxial shields around cables of the battery charger system 100 and/or mobile power distribution system 300 can be provided as part of the interlock system 420. In some embodiments, the interlock system 420 detects disruptions in the conductors in the cabling of the power bus 102 via time-domain reflectometry. Additionally and/or alternatively, resonance characterization of the conductors in the cabling of the power bus 102 can be used to detect disruptions.

FIG. 13 depicts a flow diagram of an example bus power source control method 500 according to example embodiments of the present disclosure. FIG. 13 depicts steps performed in a particular order for purposes of illustration and discussion. Those of ordinary skill in the art, using the disclosures provided herein, will understand that various steps of any of the methods described herein can be omitted, expanded, performed simultaneously, rearranged, and/or modified in various ways without deviating from the scope of the present disclosure. In addition, various steps (not illustrated) can be performed without deviating from the scope of the present disclosure. Additionally, the method 500 is generally discussed with reference to the battery charger system 100 and the mobile power distribution system 300 described above with reference to FIGS. 1-12C. However, it should be understood that aspects of the present method 500 can find application with any suitable battery charger system and/or mobile power distribution system.

The method 500 can begin at (502). As will be discussed in greater detail below, the method 500 can be implemented by the battery charger system 100 (e.g., controller 150) and/or the mobile power distribution system 300 to control any of the bus power sources (e.g., input power sources 110, 112) discussed above with reference to FIGS. 1-12C.

The method 500 can include, at (504), determining whether there is any external power available to the one or more input power source(s). For instance, as noted above, the one or more input power source(s) can be configured to take in external power from an external power source and convert the external power into bus power for use by the power bus (e.g., power bus 102).

If there is no external power available at (504), the method 500 can proceed to (506), where the one or more input power source(s) are configured to wait for a period of time before returning back to (504). Those of ordinary skill in the art will understand that the waiting period can be any suitable length of time without deviating from the scope of the present disclosure.

If there is external power available at (504), the method 500 can proceed to (508), where the one or more input power source(s) are configured to wait for the external power to stabilize.

The method 500 can include, at (510), determining whether the external power has stabilized. If the external power is not yet stable at (510), the method 500 can return to (508), where the one or more input power source(s) are configured to continue to wait for the external power to stabilize.

When the external power stabilizes, the method 500 can proceed to (512), where the one or more input power source(s) are configured to begin providing bus power to the power bus. Furthermore, in response to providing the bus power to the power bus at (512), the method 500 can include, at (514), announcing (e.g., communicating) the availability of bus power on the power bus. For instance, in some embodiments, the one or more input power source(s) are configured to communicate to the rest of the system via a communication bus (e.g., communication bus 104) that bus power is available on the power bus. Additionally and/or alternatively, the one or more input power source(s) can communicate that bus power is available on the power bus via one or more wireless communication links.

Following the announcement of available bus power at (514), the method 500 includes, at (516), an additional waiting period. In this waiting period, as discussed above, any of the one or more load source(s) can request to use the bus power added to the power bus at (512).

At (518), the method 500 can include determining whether the available bus power on the power bus has changed. If the available bus power has not changed at (518), the method 500 can return to the waiting period at (516).

If the available bus power has changed at (518), the method 500 can proceed to (520), where the one or more load device(s) are configured to announce the discontinuation of bus power to the power bus. For instance, at (520), the one or more input power source(s) are configured to communicate to the rest of the system via the communication bus that the one or more input power source(s) are discontinuing power supply to the power bus. Additionally and/or alternatively, the one or more input power source(s) can communicate the discontinuation of bus power supply to the system via the one or more wireless communication links.

Following the announcement of the power discontinuation at (520), the method 500 can proceed to (522), where the one or more input power source(s) are configured to stop providing bus power to the power bus.

After the power discontinuation at (522), the method 500 can proceed to the waiting period at (506). After the waiting period at (506), the method 500 can repeat itself by proceeding back to (504) to determine whether external power is available to the one or more input power source(s).

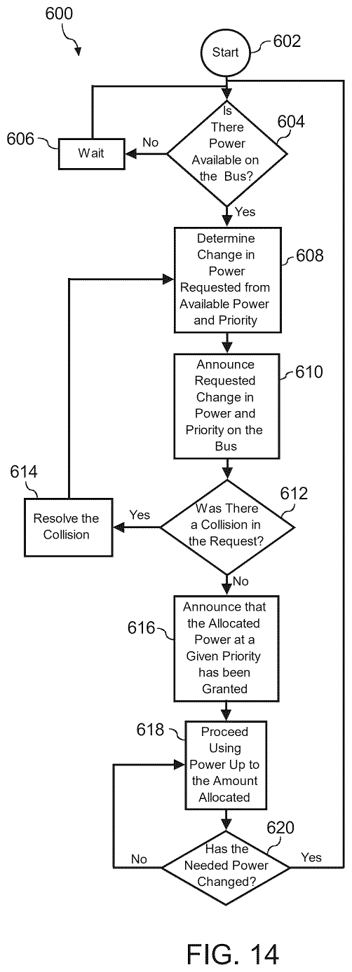

FIG. 14 depicts a flow diagram of an example bus power consumer control method 600 according to example embodiments of the present disclosure. FIG. 14 depicts steps performed in a particular order for purposes of illustration and discussion. Those of ordinary skill in the art, using the disclosures provided herein, will understand that various steps of any of the methods described herein can be omitted, expanded, performed simultaneously, rearranged, and/or modified in various ways without deviating from the scope of the present disclosure. In addition, various steps (not illustrated) can be performed without deviating from the scope of the present disclosure. Additionally, the method 600 is generally discussed with reference to the battery charger system 100 and the mobile power distribution system 300 described above with reference to FIGS. 1-12C. However, it should be understood that aspects of the present method 600 can find application with any suitable battery charger system and/or mobile power distribution system.

The method 600 can begin at (602). As will be discussed in greater detail below, the method 600 can be implemented by the battery charger system 100 (e.g., controller 150) and/or the mobile power distribution system 300 to control any consumer of bus power (e.g., battery chargers 120, 122, output adapter 130, battery bank 140) discussed above with reference to FIGS. 1-12C.

At (604), the method 600 can include determining whether there is any bus power available on a power bus of the battery charger system 100. For instance, as noted above, any consumer of bus power (e.g., battery chargers 120, 122, output adapter 130, battery bank 140) can request power from one or more input source(s) of the battery charger system 100 if bus power is available on the power bus (e.g., power bus 102).

If there is no bus power available on the power bus at (604), the method 600 can proceed to (606), where the consumers of bus power are configured to wait for a period of time before returning back to (604). Those of ordinary skill in the art will understand that the waiting period can be any suitable length of time without deviating from the scope of the present disclosure.

If there is bus power available on the power bus at (604), the method 600 can proceed to (608). At (608), the method 600 can include determining a change in the amount of power requested from the power available on the bus and priority amongst the consumers of bus power. For instance, as noted above, the power bus can transmit the bus power to the consumer of bus power based at least in part on the one or more power requests and one or more prioritization schemes.

The method 600 can then proceed to (610), where the method 600 can include announcing the change in requested bus power and priority on the bus. For instance, as noted above, any of the consumers of bus power can communicate data indicative of a power request from the power bus and data indicative of priority via a communication bus (e.g., communication bus 104) of the battery charger system 100.

The method 600 can then proceed to (612), where the method 600 can include determining whether there is a collision in the power request announced at (610). For instance, as noted above, the consumer of bus power can request and charge at its rated power if a sufficient amount of bus power is available on the power bus. However, if there is not sufficient power on the power bus, the consumer of bus power can draw a reduced amount of power to prevent an overload to the battery charger system. Furthermore, in instances where two consumer devices of equal prioritization request the same amount of power, example embodiments of the present disclosure provide a variety of claim collision methods.

If a claim collision is determined to exist at (612), the method 600 can proceed to (614). At (614), the method 600 can include resolving the collision. For instance, as noted above, when a claim collision exists, the collision can be resolved via a variety of claim collision arbitration methods, such as, e.g., random time backoff and serial number prioritization. Once the collision is resolved at (614), the method 600 can return to (608).

If no claim collision is determined to exist at (612), the method 600 can proceed to (616). At (616), the method 600 can include announcing that the power requested at the priority determined at (608) has been granted. For instance, as noted above, the announcement can be communicated to the battery charger system 100 via the communication bus 104. Additionally and/or alternatively, the announcement can be communicated to the battery charger system 100 via one or more wireless communication links.

After transmitting the announcement to the battery charger system 100 at (616), the method 600 can proceed to (618). At (618), the method 600 can include using the allocated amount of bus power announced at (616). At (620), the method 600 can include determining whether the amount of power needed by the consumer of bus power has changed. In instances where the amount of bus power needed has not changed at (618), the method 600 can return to (618), where the consumer of bus power can continue using the allocated power. In instances where the amount of bus power needed has changed at (618), the method 600 can return to (604), where the availability of bus power on the power bus can be determined.

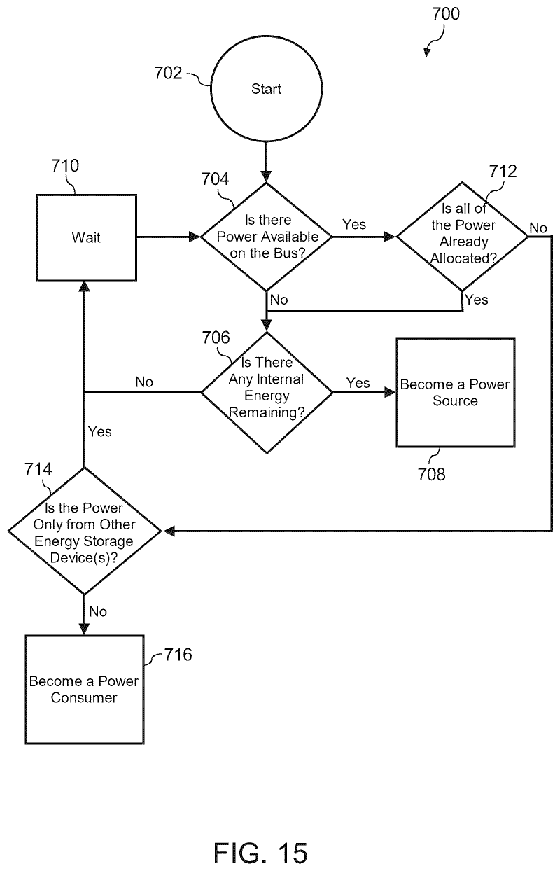

FIG. 15 depicts a flow diagram of an example energy storage device control method 700 according to example embodiments of the present disclosure. FIG. 15 depicts steps performed in a particular order for purposes of illustration and discussion. Those of ordinary skill in the art, using the disclosures provided herein, will understand that various steps of any of the methods described herein can be omitted, expanded, performed simultaneously, rearranged, and/or modified in various ways without deviating from the scope of the present disclosure. In addition, various steps (not illustrated) can be performed without deviating from the scope of the present disclosure. Additionally, the method 700 is generally discussed with reference to the battery charger system 100 and the mobile power distribution system 300 described above with reference to FIGS. 1-12C. However, it should be understood that aspects of the present method 700 can find application with any suitable battery charger system and/or mobile power distribution system.

The method 700 can begin at (702). As will be discussed in greater detail below, the method 700 can be implemented by the battery charger system 100 (e.g., controller 150) and/or the mobile power distribution system 300 to control any energy storage device (e.g., battery bank 140) discussed above with reference to FIGS. 1-12C.

The method 700 can include, at (704), determining whether there is any bus power available on a power bus (e.g., power bus 102). For instance, as noted above, whether the battery bank 140 takes bus power from the power bus or provides bus power to the power bus can depend on the presence of additional input power source(s).

If there is no bus power available on the power bus at (704), the method 700 can proceed to (706). At (706), the method 700 can include determining whether the energy storage device has any remaining internal energy. For instance, as discussed above, the battery bank 140 can be a bidirectional power source. As such, the battery bank 140 can be configured to store energy in the battery 222. If the energy storage device does have remaining internal energy at (706), the method 700 can proceed to (708), where the energy storage device is configured to become a power source for the system. For instance, as discussed above, when bus power from the one or more input power source(s) is not available to the system, the battery bank 140 can be configured to become a power source for the system by providing energy stored in the battery 222 to the system.

If the energy storage device does not have any remaining internal energy at (706), the method 700 can proceed to (710), where the energy storage device is configured to wait for a period of time before returning back to (704). Those of ordinary skill in the art will understand that the waiting period can be any suitable length of time without deviating from the scope of the present disclosure.

If there is bus power available on the power bus at (704), the method 700 can proceed to (712). At (712), the method 700 can include determining whether the bus power available on the power bus has been allocated to other components of the system. If all bus power available on the power bus has been allocated at (712), the method 700 can proceed to (706) as discussed above.

If the bus power available on the power bus has not been allocated at (712), the method 700 can proceed to (714). At (714), the method 700 includes determining whether the non-allocated bus power available on the power bus is being provided to the power bus by other energy storage devices. For instance, at (714), the method 700 can provide determining whether the input power source(s) providing bus power to the power bus are other energy storage devices (e.g., battery bank 140) or other input power source(s) (e.g., input power sources 110, 112). If it is determined at (714) that the source of the available bus power is other energy storage devices, the method 700 can proceed to the waiting period discussed above at (710).

If it is determined at (714) that the source of the available bus power is not other energy storage devices, the method 700 can proceed to (716), where the energy storage device is configured to become a power consumer from the system. For instance, as discussed above, when bus power (e.g., shore power) from the one or more input power source(s) is available to the system, the battery bank 140 can be configured to become a power consumer from the system by receiving bus power from the power bus for internal storage in the battery 222 of the battery bank 140.

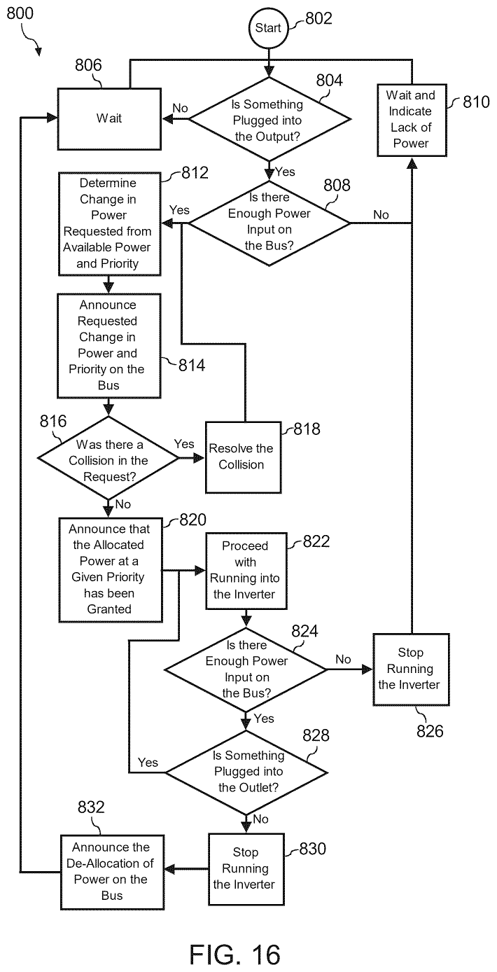

FIG. 16 depicts a flow diagram of an example output inverter device control method 800 according to example embodiments of the present disclosure. FIG. 16 depicts steps performed in a particular order for purposes of illustration and discussion. Those of ordinary skill in the art, using the disclosures provided herein, will understand that various steps of any of the methods described herein can be omitted, expanded, performed simultaneously, rearranged, and/or modified in various ways without deviating from the scope of the present disclosure. In addition, various steps (not illustrated) can be performed without deviating from the scope of the present disclosure. Additionally, the method 800 is generally discussed with reference to the battery charger system 100 and the mobile power distribution system 300 described above with reference to FIGS. 1-12C. However, it should be understood that aspects of the present method 800 can find application with any suitable battery charger system and/or mobile power distribution system.

The method 800 can begin at (802). As will be discussed in greater detail below, the method 800 can be implemented by the battery charger system 100 (e.g., controller 150) and/or the mobile power distribution system 300 to control any output inverter device (e.g., output adapter 130) discussed above with reference to FIGS. 1-12C.

The method 800 can include, at (804), determining whether any device is connected to the output inverter device. For instance, as noted above, the battery charger system 100 can include one or more output inverter device(s) (e.g., output adapter 130) configured to provide AC power to devices requiring AC power. Furthermore, in some embodiments, one or more pass-through plugs in the one or more input power device(s) can provide AC power to the one or more output inverter device(s).

If no device is determined to be connected to the output inverter device at (804), the method 800 can proceed to (806), where the output inverter devices are configured to wait for a period of time before returning back to (804). Those of ordinary skill in the art will understand that the waiting period can be any suitable length of time without deviating from the scope of the present disclosure.

If a device is determined to be connected to the output inverter device at (804), the method 800 can proceed to (808). At (808), the method 800 can include determining whether the amount of bus power available on the power bus (e.g., power bus 102) is sufficient. For instance, whether the amount of bus power available on the power bus is sufficient can be determined, based at least in part, on a power rating of the one or more device(s) connected to the output inverter device.

If it is determined at (808) that there is not sufficient bus power available on the power bus, the method 800 can proceed to (810), where the output inverter devices are configured to wait for a period of time before returning back to (804). Furthermore, at (810), the method 800 can include indicating a lack of sufficient available bus power via, e.g., a GUI, LED, etc.

If it is determined at (808) that there is sufficient bus power available on the power bus, the method 800 can proceed to (812). At (812), the method 800 can include determining a change in power requested from the bus power available on the power bus and priority. For instance, as noted above, the power bus can transmit the bus power to the consumers of bus power (e.g., output inverter devices) based at least in part on the one or more power requests and one or more prioritization schemes.

The method 800 can then proceed to (814), where the method 800 can include announcing the change in requested bus power and priority on the bus. For instance, as noted above, any of the consumers of bus power can communicate data indicative of a power request from the power bus and data indicative of priority via a communication bus (e.g., communication bus 104) of the battery charger system 100. Additionally and/or alternatively, any of the consumers of bus power can communicate the data indicative of the power request from the power bus and data indicative of the priority via one or more wireless communication links.

The method 800 can then proceed to (816), where the method 800 can include determining whether there is a collision in the power request announced at (814). For instance, as noted above, the output inverter device can request and charge at its rated power if a sufficient amount of bus power is available on the power bus. However, if there is not sufficient power on the power bus, the output inverter device can draw a reduced amount of power to prevent an overload to the battery charger system. Furthermore, in instances where two consumer devices of equal prioritization request the same amount of power, example embodiments of the present disclosure provide a variety of claim collision methods.

If a claim collision is determined to exist at (816), the method 800 can proceed to (818). At (818), the method 800 can include resolving the collision. For instance, as noted above, the collision can be resolved via a variety of claim collision arbitration methods, such as, e.g., random time backoff and serial number prioritization. Once the collision is resolved at (818), the method 800 can return to (812).

If no claim collision is determined to exist at (816), the method 800 can proceed to (820). At (820), the method 800 can include announcing that the power requested at the priority determined at (812) has been granted. For instance, as noted above, the announcement can be communicated to the battery charger system 100 via the communication bus 104. Additionally and/or alternatively, the announcement can be communicated to the battery charger system 100 via one or more wireless communication links.

The method 800 can then proceed to (822). At (822), the method 800 can include proceeding with running the output inverter device at the bus power announced at (820). At (824), the method 800 can include determining whether the amount of bus power available on the power bus (e.g., power bus 102) is sufficient in a similar manner as set forth above with reference to (808).

If it is determined at (824) that there is not enough bus power available on the power bus, the method 800 can proceed to (826). At (826), the method 800 can include halting the flow of bus power to the output inverter device. Once the bus power is halted at (826), the method 800 can return to (810), where the output inverter devices are configured to wait for a period of time before returning back to (804). Furthermore, at (810), the method 800 can include indicating a lack of sufficient available bus power via, e.g., a GUI, LED, etc.

If it is determined at (824) that there is enough bus power available on the power bus, the method 800 can proceed to (828). At (828), the method 800 can include determining whether any device is connected to the output inverter device in a similar manner as set forth above with reference to (804). If a device is determined to be connected to the output inverter device at (828), the method 800 can return to (822) and proceed with running the output inverter device at the bus power announced at (820).

If no device is determined to be connected to the output inverter device at (828), the method 800 can proceed to (830). At (830), the method 800 can include halting the flow of bus power to the output inverter device in a similar manner as set forth above with reference to (826). Once the bus power is halted at (830), the method 800 can proceed to (832). At (832), the method 800 can include announcing the de-allocation of power on the power bus to the output inverter device. The announcement at (832) can be made in a similar manner to the announcement set forth above with reference to (814).

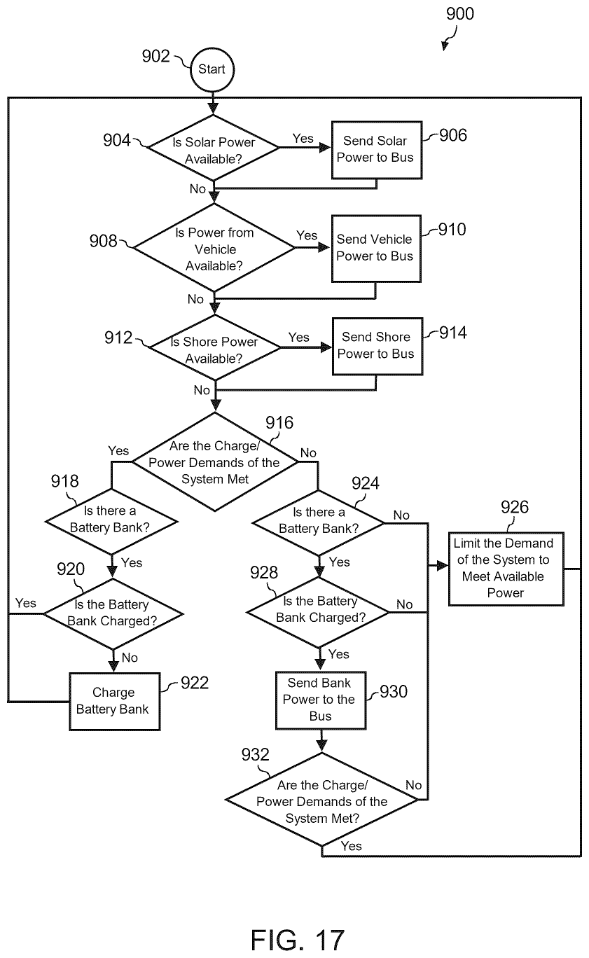

FIG. 17 depicts a flow diagram of an example input power source sharing method 900 according to example embodiments of the present disclosure. FIG. 17 depicts steps performed in a particular order for purposes of illustration and discussion. Those of ordinary skill in the art, using the disclosures provided herein, will understand that various steps of any of the methods described herein can be omitted, expanded, performed simultaneously, rearranged, and/or modified in various ways without deviating from the scope of the present disclosure. In addition, various steps (not illustrated) can be performed without deviating from the scope of the present disclosure. Additionally, the method 900 is generally discussed with reference to the battery charger system 100 and the mobile power distribution system 300 described above with reference to FIGS. 1-12C. However, it should be understood that aspects of the present method 900 can find application with any suitable battery charger system and/or mobile power distribution system.

The method 900 can begin at (902). As will be discussed in greater detail below, the method 900 can be implemented by the battery charger system 100 (e.g., controller 150) and/or the mobile power distribution system 300 to control power distribution to any consumer of bus power (e.g., battery chargers 120, 122, output adapter 130, battery bank 140) discussed above with reference to FIGS. 1-12C.

The method 900 can include, at (904), determining whether any solar power is available to the battery charger system 100. For instance, as noted above, one or more input power source(s) (e.g., input power sources 110, 112) can be any suitable type of input power source, such as, e.g., a solar power system, a vehicle battery, shore power, etc. If solar power is available at (904), the method can proceed to (906), where the method 900 includes providing the solar power to the power bus (e.g., power bus 102). After providing the solar power to the power bus at (906), the method can proceed to (908).

If no solar power is available at (904), the method 900 can proceed to (908). At (908), the method 900 can include determining whether any power from a vehicle (e.g., car, truck, etc.) is available. If power from a vehicle is available at (908), the method 900 can proceed to (910), where the method 900 includes providing the vehicle power to the power bus. After providing the vehicle power to the power bus at (910), the method 900 can proceed to (912).

If no vehicle power is available at (908), the method 900 can proceed to (912). At (912), the method 900 can include determining whether any shore power is available. If shore power is available at (912), the method 900 can proceed to (914), where the method 900 includes providing shore power to the power bus. After providing shore power to the power bus at (914), the method 900 can proceed to (916).

If no shore power is available at (912), the method can proceed to (916). At (916), the method 900 can include determining whether the power demands of the battery charger system 100 are met. For instance, as noted above, the input power source(s) can communicate an amount of power available to the power bus, and the one or more load device(s) can communicate an amount of power requested by each of the one or more load device(s).

If the power demands of the battery charger system 100 are met at (916), the method 900 can proceed to (918). At (918), the method 900 can include determining whether a battery bank (e.g., energy storage device) is available to the battery charger system. As noted above, in some embodiments, the battery charger system 100 can include a bidirectional battery bank 140. If a battery bank is available at (918), the method 900 can proceed to (920). At (920), the method 900 can include determining whether the battery bank identified at (918) is charged. If the battery bank is charged at (920), the method 900 can return to (904). If the battery bank is not charged at (920), the method 900 can proceed to (922). At (922), the method 900 can include charging the battery bank before returning to (904).

If the power demands of the battery charger system are not met at (916), the method 900 can proceed to (924). At (924), the method 900 can include determining whether a battery bank is available to the battery charger system 100 in a similar manner as set forth above with reference to (918). If a battery bank is not available at (924), the method 900 can proceed to (926). At (926), the method 900 can include limiting the bus power demand of the battery charger system 100. In this way, at (926), the method 900 can limit the power demand of the battery charger system in order to meet the power demands of the battery charger system discussed above with reference to (916).

If a battery bank is available at (924), the method 900 can proceed to (928). At (928), the method 900 can include determining whether the battery bank identified at (924) is charged. If the battery bank is not charged at (928), the method 900 can proceed to (926) to limit the power demand of the system as set forth above. If the battery bank is charged at (928), the method 900 can proceed to (930). At (930), the method 900 can include sending power stored in the battery bank to the power bus.

After transmitting the power stored in the battery bank to the power bus, the method 900 can include determining whether the power demands of the battery charger system 100 are met in a similar manner as set forth above with reference to (916). If the power demands are not met at (932), the method 900 can return to (926) to limit the power demand of the battery charger system as set forth above. If the power demands are met at (932), the method 900 can return to (904).

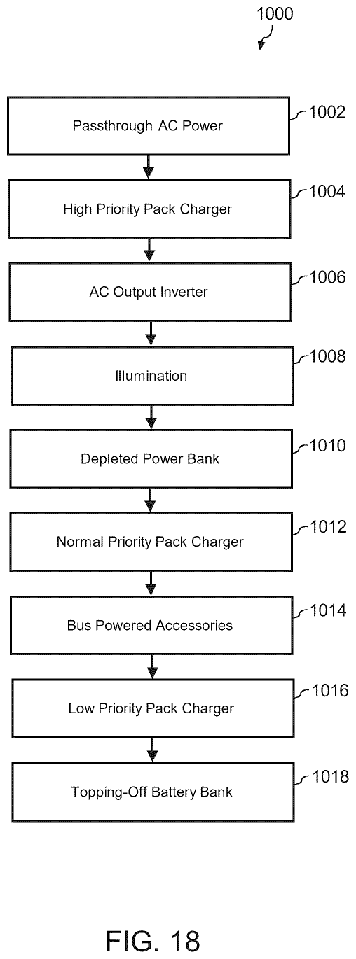

FIG. 18 depicts an example power consumer prioritization scheme 1000 according to example embodiments of the present disclosure. Those of ordinary skill in the art will understand that the order depicted in FIG. 18 is for purposes of illustration and can vary without deviating from the scope of the present disclosure. Furthermore, as noted above, the prioritization scheme 1000 depicted in FIG. 18 can be used to determine a priority level for the one or more load device(s) (e.g., battery chargers 120, 122, output adapter 130, battery bank 140). As shown in FIG. 18, a variety of exemplary power consumers(s) are listed in descending order, with passthrough AC power having the highest priority 1002 and topping-off a battery bank having the lowest priority 1018.

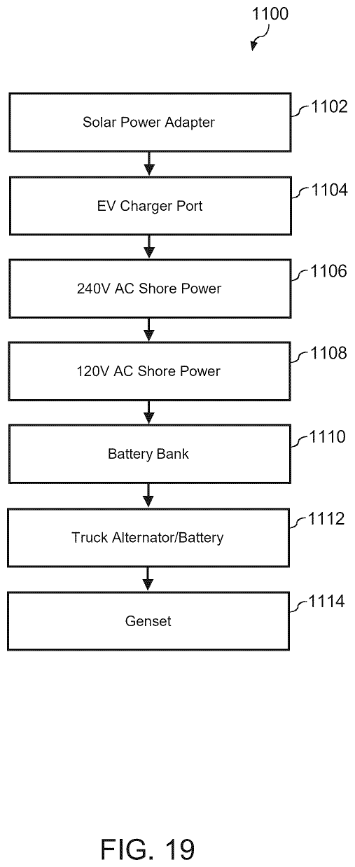

FIG. 19 depicts an example power source prioritization scheme 1100 according to example embodiments of the present disclosure. Those of ordinary skill in the art will understand that the order depicted in FIG. 19 is for purposes of illustration and can vary without deviating from the scope of the present disclosure. Furthermore, as noted above, the prioritization scheme 1100 depicted in FIG. 19 can be used to determine a priority level for the one or more input power source(s) (e.g., input power sources 110, 112). As shown in FIG. 19, a variety of exemplary input power source(s) are listed in descending order, with a solar power adapter having the highest priority 1102 and a Genset (e.g., portable generator) having the lowest priority 1114.

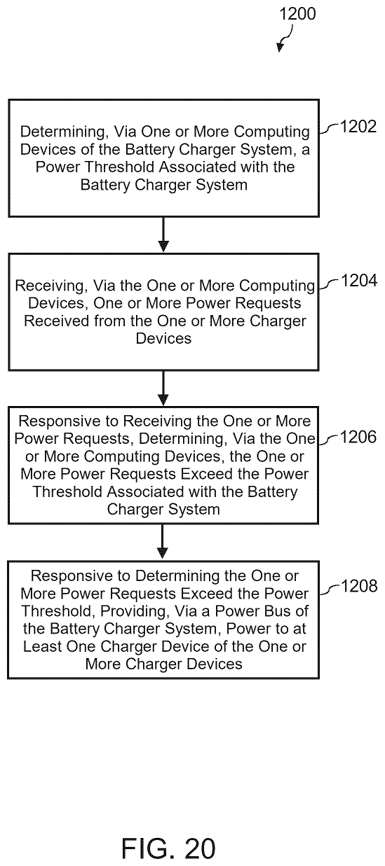

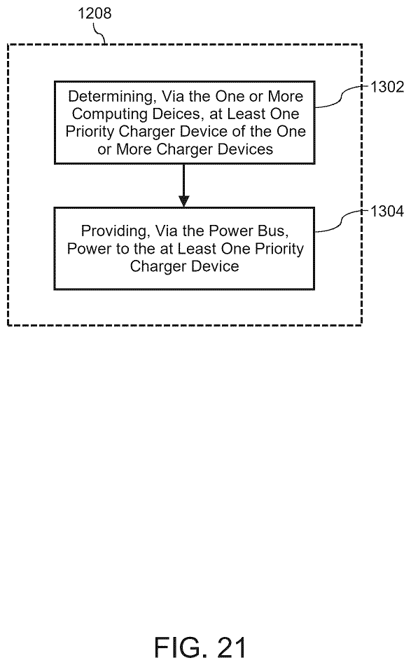

FIGS. 20-21 depict flow diagrams of an example method 1200 for providing power to one or more charger devices of a battery charger system according to example embodiments of the present disclosure. FIGS. 20-21 depict steps performed in a particular order for purposes of illustration and discussion. Those of ordinary skill in the art, using the disclosures provided herein, will understand that various steps of any of the methods described herein can be omitted, expanded, performed simultaneously, rearranged, and/or modified in various ways without deviating from the scope of the present disclosure. In addition, various steps (not illustrated) can be performed without deviating from the scope of the present disclosure. Additionally, the method 1200 is generally discussed with reference to the battery charger system 100 and the mobile power distribution system 300 described above with reference to FIGS. 1-12C. However, it should be understood that aspects of the present method 1200 can find application with any suitable battery charger system and/or mobile power distribution system.

At (1202), the method 1200 can include determining, via one or more computing devices of the battery charger system, a power threshold associated with the battery charger system. For instance, one or more computing devices of the battery charger system (e.g., battery charger system 100) can receive data indicative of a maximum power output from each of one or more input power source(s) (e.g., input power sources 110, 112). In some embodiments, the power threshold can be the maximum power output from each of the one or more input power source(s). Additionally and/or alternatively, the power threshold can be a percentage (e.g., about 95 percent) of the maximum power output from each of the one or more input power source(s).

At (1204), the method 1200 can include receiving, via the one or more computing devices, one or more power requests received from the one or more charger devices. For instance, the one or more computing devices of the battery charger system can receive data indicative of one or more power requests from one or more charger devices (e.g., battery chargers 120, 122) via a communication bus (e.g., communication bus 104) of the battery charger system. Additionally and/or alternatively, the one or more computing devices of the battery charger system can receive the data indicative of the one or more power requests from the one or more charger devices via one or more wireless communication links (e.g., WiFi, Bluetooth, cellular communication).

At (1206), the method 1200 can include, responsive to receiving the one or more power requests, determining, via the one or more computing devices, the one or more power requests exceed the power threshold associated with the battery charger system. For instance, in response to receiving the one or more power requests from the one or more charger devices at (1204), the one or more computing devices of the battery charger system can determine that the total power requested by the one or more charger devices exceeds the power threshold determined at (1202).

At (1208), the method 1200 can include, responsive to determining the one or more power requests exceed the power threshold, providing, via a power bus of the battery charger system, power to at least one charger device of the one or more charger devices. For instance, in response to determining the one or more power requests from the one or more charger devices exceeds the power threshold at (1206), a power bus (e.g., power bus 102) of the battery charger system can provide power to at least one charger device of the one or more charger devices. In some embodiments, the power bus can provide power to each of the one or more charger devices based at least in part on one or more arbitration schemes, such as, e.g., a centralized arbitration scheme or a decentralized arbitration scheme. Additionally and/or alternatively, the power bus can transmit the bus power to the one or more charger devices based at least in part on the one or more power requests and one or more prioritization schemes.

Referring now to FIG. 21 at (1302), the method 1200 can include determining, via the one or more computing devices, at least one priority charger device of the one or more charger devices. For instance, the one or more computing devices of the battery charger system can determine at least one priority charger device based at least in part on one or more prioritization schemes, such as, e.g., a time-dependent prioritization scheme, a user-input prioritization scheme, or an intrinsic prioritization scheme. Additionally and/or alternatively, the one or more prioritization schemes can used to determine at least one priority load device and at least one priority input power device in a similar manner.

Referring still to FIG. 21, at (1304), the method 1200 can include providing, via the power bus, power to the at least one priority charger device. For instance, in response to determining the at least one priority charger device at (1302), the one or more input power source(s) can provide power to the at least one priority charger device via the power bus.

As noted above, the one or more prioritization schemes can be applied to each component of the battery charger system. For instance, in some embodiments, the one or more computing devices of the battery charger system can determine at least one priority

1. A battery charger system, comprising:
one or more input power sources configured to provide bus power to the battery charger system;
a power bus coupled to the one or more input power sources;
a communication bus coupled to the one or more input power sources and to the power bus; and
one or more charger devices coupled to the power bus and to the communication bus, the one or more charger devices configured to receive bus power from the power bus,
wherein the battery charger system is configured to provide bus power to the one or more charger devices based at least in part on one or more arbitration schemes configured to allocate the bus power between the one or more charger devices.

2. The battery charger system of claim 1, wherein the one or more arbitration schemes comprise at least one of a centralized arbitration scheme or a decentralized arbitration scheme.

3. The battery charger system of claim 2, further comprising a controller coupled to the communication bus, the controller configured to:
determine one or more electrical characteristics of the one or more input power sources;
process one or more power requests received from each of the one or more charger devices; and
distribute the bus power to each of the one or more charger devices based at least in part on the one or more electrical characteristics of the one or more input power sources and the one or more power requests received from each of the one or more charger devices.

4. The battery charger system of claim 2, wherein the one or more input power sources are configured to:
receive one or more power requests from each the one or more charger devices via the communication bus; and
transmit bus power to the one or more charger devices based at least in part on the one or more power requests from each of the one or more charger devices and one or more prioritization schemes.

5. The battery charger system of claim 4, wherein the one or more prioritization schemes comprise at least one of a time-dependent prioritization scheme, a user-input prioritization scheme, or an intrinsic prioritization scheme.

6. The battery charger system of claim 1, wherein the one or more input power sources are configured to provide the bus power to the power bus in a parallel configuration.

7. The battery charger system of claim 6, wherein the one or more input power sources comprise at least one of a shore power source, a vehicle battery, an inverter, a solar power system, or a battery bank.

8. The battery charger system of claim 1, further comprising an output adapter configured to convert bus power received from the battery charger system into AC power, the output adapter further configured to provide the AC power to one or more external devices configured to operate on AC power.

9. The battery charger system of claim 1, further comprising a bidirectional battery bank configured to:
receive bus power from the one or more input power sources; and
provide bus power to the one or more charger devices.

10. The battery charger system of claim 1, wherein the one or more charger devices are configured to transmit data indicative of one or more electrical characteristics of the one or more charger devices, the one or more electrical characteristics of the one or more charger devices comprising a maximum power draw capacity of each of the one or more charger devices, requested charger power of each of the one or more charger devices, and current power draw of each of the one or more charger devices.

11. The battery charger system of claim 10, wherein the one or more charger devices are configured to transmit the data indicative of one or more electrical characteristics of the one or more charger devices via the communication bus.

12. The battery charger system of claim 10, wherein the one or more charger devices are configured to transmit the data indicative of one or more electrical characteristics of the one or more charger devices via a wireless communication link.

13.-21. (canceled)

22. A mobile power distribution system, comprising:
a wireless module operable to communicate data associated with the mobile power distribution system via one or more wireless communication links;
a display comprising a graphical user interface; and
a battery charger system configured to provide bus power to one or more charger devices based at least in part on one or more arbitration schemes, the battery charger system comprising:
one or more input power sources;
a power bus coupled to the one or more input power sources; and
a communication bus coupled to the one or more input power sources and to the power bus.

23. The mobile power distribution system of claim 22, wherein the wireless module is operable to communicate the data associated with the mobile power distribution system via the one or more wireless communication links using a wireless communication protocol, the wireless communication protocol comprising at least one of WiFi, Bluetooth, or a cellular communication protocol.

24. The mobile power distribution system of claim 22, wherein the display is configured to display one or more metrics indicative of system performance of the mobile power distribution system.

25. The mobile power distribution system of claim 22, wherein the one or more arbitration schemes comprise at least one of a centralized arbitration scheme or a decentralized arbitration scheme.

26. A method for providing power to one or more charger devices of a battery charger system comprising one or more input power sources, the method comprising:
determining, via one or more computing devices of the battery charger system, a power threshold associated with the battery charger system;
receiving, via the one or more computing devices, one or more power requests received from the one or more charger devices;
responsive to receiving the one or more power requests, determining, via the one or more computing devices, the one or more power requests exceed the power threshold associated with the battery charger system; and
responsive to determining the one or more power requests exceed the power threshold, providing, via a power bus of the battery charger system, power to at least one charger device of the one or more charger devices.

27. The method of claim 26, wherein providing power to at least one charger device of the one or more charger devices comprises:
determining, via the one or more computing devices, at least one priority charger device of the one or more charger devices; and
providing, via the power bus, power to the at least one priority charger device.

28. The method of claim 26, wherein providing power to at least one charger device of the one or more charger devices comprises providing, via the power bus, power to each of the one or more charger devices based at least in part on one or more arbitration schemes.

29. The method of claim 28, wherein the one or more arbitration schemes comprise at least one of a centralized arbitration scheme or a decentralized arbitration scheme.

30.-48. (canceled)
